(19) United States
(12) Patent Application Publication
(10) Pub. No.: US 2024/0070792 A1
(43) Pub. Date: Feb. 29, 2024

(54) POWER MANAGEMENT SYSTEM AND POWER MANAGEMENT METHOD

(71) Applicant: TOYOTA JIDOSHA KABUSHIKI KAISHA, Toyota-shi, Aichi-ken (JP)

(72) Inventors: Mitsuaki TOMITA, Toyota-shi (JP); Maiko HAYASHI, Toyota-shi (JP); Miyako SAKAI, Toyota-shi (JP); Makito MURAMATSU, Toyota-shi (JP); Hirohiko TANIGUCHI, Yokohama-shi (JP)

(73) Assignee: TOYOTA JIDOSHA KABUSHIKI KAISHA, Toyota-shi, Aichi-ken (JP)

(21) Appl. No.: 18/453,075

(22) Filed: Aug. 21, 2023

(30) Foreign Application Priority Data
Aug. 25, 2022 (JP) 2022-134451

(51) Int. Cl. G06Q 50/06; B60L 53/18; B60L 53/67; B60L 53/68; B60L 55/00; G06Q 30/0207

(52) U.S. Cl. CPC G06Q 50/06; B60L 53/18; B60L 53/67; B60L 53/68; B60L 55/00; G06Q 30/0207

(57) ABSTRACT

A VGI system is a system in which electric power is exchanged between a power grid of an electric power utility company and a BEV, and includes a plurality of BEVs, EVSE, and a management server that manages exchange of electric power. The EVSE includes specific EVSE available to a specific vehicle among BEVs, the specific vehicle being permanently permitted to use the EVSE. The management server performs processing for temporarily permitting use of the specific EVSE by a non-specific vehicle different from the specific vehicle on condition that the non-specific vehicle uses the specific EVSE to exchange electric power with the electric power utility company and performs processing for granting an incentive to a user of the non-specific vehicle or a manager of the specific EVSE on condition that the non-specific vehicle has exchanged electric power with the electric power utility company.

### CROSS REFERENCE TO RELATED APPLICATIONS

This nonprovisional application is based on Japanese Patent Application No. 2022-134451 filed with the Japan Patent Office on Aug. 25, 2022, the entire contents of which are hereby incorporated by reference.

### BACKGROUND

### Field

This disclosure relates to a power management system and a power management method, and particularly to a power management system in which electric power is exchanged between a power supply and demand system of an electric power trading partner and a vehicle and a power management method in a power management system in which electric power is exchanged between a power supply and demand system of an electric power trading partner and a vehicle.

### Description of the Background Art

Conventionally, in an information providing system that provides information to a driver and/or a passenger through a vehicle-mounted apparatus mounted on an electrically powered vehicle, the vehicle-mounted apparatus includes notification means for notifying the driver and/or the passenger of a status of congestion of a charging station candidate that can be reached based on a remaining capacity of a battery of the vehicle, the status of congestion of the charging station candidate at a time point of arrival of the vehicle at the charging station candidate being predicted based on position information and the remaining capacity of a battery of another electrically powered vehicle present around the charging station candidate (see, for example, Japanese Patent Laying-Open No. 2011-013893).

### SUMMARY

In utilization of an electrically powered vehicle as an electric power resource, use of not only a public charging station but also a charging station privately used by each entity may be assumed.

An object of this disclosure is to provide a power management system and a power management method that can achieve increase in opportunities for utilization of a vehicle for exchange of electric power.

A power management system according to this disclosure is a system in which electric power is exchanged between a power supply and demand system of an electric power trading partner and a vehicle. The power management system includes a plurality of vehicles, a plurality of charging and discharging apparatuses each including a cable through which electric power exchanged with the vehicle passes and a connector for connection of the cable to the vehicle, and a server that manages exchange of electric power. Each charging and discharging apparatus of the charging and discharging apparatuses includes a specific charging and discharging facility available to a specific vehicle of the vehicles, the specific vehicle being permanently permitted to use the charging and discharging apparatus. The server performs processing for temporarily permitting use the specific charging and discharging facility by a non-specific vehicle different from the specific vehicle on condition that the non-specific vehicle uses the specific charging and discharging facility to exchange electric power with the trading partner, and performs processing for granting an incentive to a user of the non-specific vehicle or a manager of the specific charging and discharging facility on condition that the non-specific vehicle has exchanged electric power with the trading partner.

According to such a configuration, even the non-specific vehicle different from the specific vehicle permanently permitted to use the specific charging and discharging facility can be used for exchange at the specific charging and discharging facility, of electric power with the power supply and demand system of the electric power trading partner. Consequently, the power management system that can achieve increase in opportunities for utilization of the vehicle for exchange of electric power can be provided.

The server may grant the manager the incentive in accordance with a scale or performance of the specific charging and discharging facility.

According to such a configuration, the manager that offers the specific charging and discharging facility for utilization of the vehicle for exchange of electric power can be motivated to offer a charging and discharging facility larger in scale and higher in performance.

The server may search for the specific charging and discharging facility in accordance with desire of the user of the non-specific vehicle in response to a request for search for the specific charging and discharging facility and transmit a result of search to the user.

According to such a configuration, the user of the non-specific vehicle can be notified of the specific charging and discharging facility in accordance with desire of the user. Consequently, convenience of the user can be improved.

The server may search for the specific charging and discharging facility available on a day when the specific vehicle does not use the specific charging and discharging facility. According to such a configuration, the specific charging and discharging facility can be made available to the non-specific vehicle on the day when the specific vehicle does not use the specific charging and discharging facility.

According to another aspect of this disclosure, a power management method is a method of managing electric power in a power management system in which electric power is exchanged between a power supply and demand system of an electric power trading partner and a vehicle. The power management system includes a plurality of vehicles, a plurality of charging and discharging apparatuses each including a cable through which electric power exchanged with the vehicle passes and a connector for connection of the cable to the vehicle, and a server that manages exchange of electric power. Each charging and discharging apparatus of the charging and discharging apparatuses includes a specific charging and discharging facility available to a specific vehicle of the vehicles, the specific vehicle being permanently permitted to use the charging and discharging apparatus. The power management method includes performing, by the server, processing for temporarily permitting use the specific charging and discharging facility by a non-specific vehicle different from the specific vehicle on condition that the non-specific vehicle uses the specific charging and discharging facility to exchange electric power with the trading partner, and performing, by the server, processing for granting an incentive to a user of the non-specific vehicle or a manager of the specific charging and discharging facility on condition that the non-specific vehicle has exchanged electric power with the trading partner.

According to such a configuration, the power management method that can achieve increase in opportunities for utilization of the vehicle for exchange of electric power can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a VGI system according to this embodiment.

FIG. 2 is a diagram of a communication system of the VGI system.

FIG. 3 is a diagram showing a configuration of a BEV.

FIG. 4 is a diagram showing an input apparatus and a notification apparatus mounted in the vicinity of a driver's seat of the BEV.

FIG. 5 is a diagram for illustrating the BEV connected to public EVSE.

FIG. 6 is a diagram for illustrating overview of search for a parking lot provided with EVSE in the first embodiment.

FIG. 7 is a flowchart showing a flow of processing for search for a parking lot including EVSE that can participate in a VPP in the VGI system in this embodiment.

FIG. 8 is a diagram for illustrating overview of search for a parking lot provided with EVSE in a second embodiment.

### DESCRIPTION OF THE PREFERRED EMBODIMENTS

### First Embodiment

An embodiment of the present disclosure will be described in detail below with reference to the drawings. The same or corresponding elements in the drawings have the same reference characters allotted and description thereof will not be repeated.

An electric power system dependent on a large-scale power plant (an intensive energy resource) possessed by an electric power utility company has recently been reviewed and a scheme for utilizing an energy resource possessed by each demand side (which is also referred to as “demand side resources (DSR)” below) has been constructed. The DSR functions as distributed energy resources (which are also referred to as “DER” below).

A virtual power plant (VPP) has been proposed as a scheme for utilizing the DSR for an electric power system. The VPP refers to a scheme in which a large number of DER (for example, DSR) are put together according to a sophisticated energy management technology that makes use of the Internet of Things (IoT) and the DER are remotely controlled as being integrated as if the DER functioned as a single power plant. In the VPP, an electric utility that puts the DER together to provide an energy management service is referred to as an “aggregator.” An electric power utility company, for example, in coordination with an aggregator, can balance between supply and demand of electric power based on demand response (DR).

In a vehicle grid integration (VGI) system according to this embodiment, a vehicle including a power storage (more specifically, an electric vehicle (an electrically powered vehicle capable of external charging and discharging such as a battery electric vehicle (BEV) and a plug-in hybrid electric vehicle (PHEV) below) is adopted as DSR for implementing the VPP.

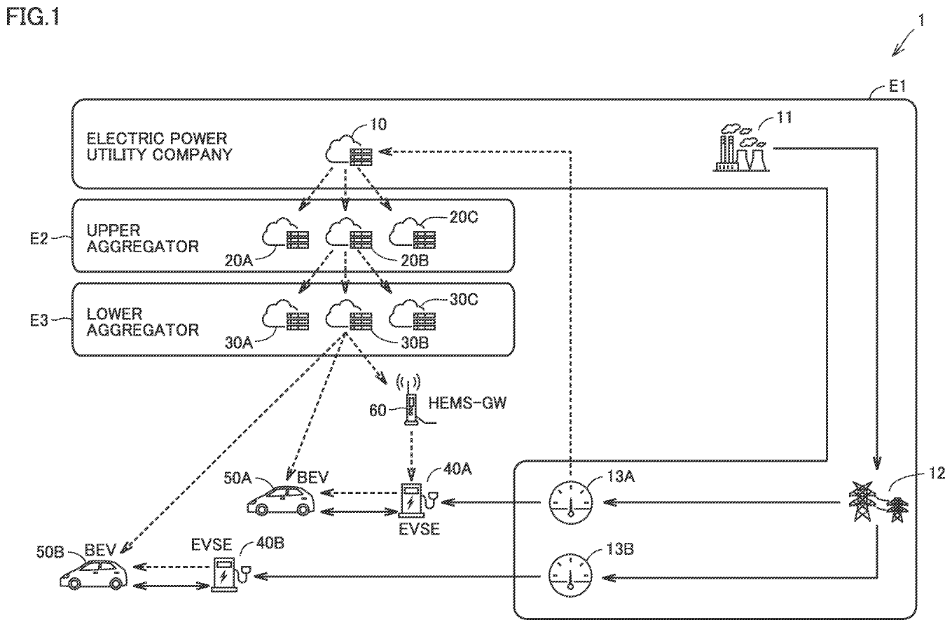

FIG. 1 is a diagram showing a configuration of a VGI system according to this embodiment. Referring to FIG. 1, a VGI system 1 includes an electric power utility company E1, an upper aggregator E2, and a lower aggregator E3.

Electric power utility company E1 generates and supplies electric power. Electric power utility company E1 can make a profit, for example, by dealing with a demand side (for example, an individual or a company) that uses electric power. Electric power utility company E1 maintains and manages a server 10, a power plant 11, a power transmission and distribution facility 12, and smart meters 13A and 13B.

Power plant 11 includes a power generator that generates electricity and supplies electric power generated by the power generator to power transmission and distribution facility 12. Any system for power generation by power plant 11 is applicable, and for example, any of thermal power generation, hydroelectric power generation, wind power generation, nuclear power generation, and solar photovoltaic power generation may be applicable. Power transmission and distribution facility 12 includes a power line, a substation, and an electricity distribution line and transmits and distributes electric power supplied from power plant 11. Power plant 11 and power transmission and distribution facility 12 construct a power grid (power system).

Each of smart meters 13A and 13B measures an amount of power usage each time a prescribed time period elapses (for example, each time thirty minutes elapse), stores the measured amount of power usage, and transmits the measured amount of power usage to server 10. For example, IEC (DLMS/COSEM) can be adopted as a protocol for communication between smart meters 13A and 13B and server 10. Each of smart meters 13A and 13B measures an amount of power usage in EVSE 40A and 40B which will be described later (for example, an amount of electric power used for charging of BEVs 50A and 50B). Electric power utility company E1 corresponds to a managerial utility of each of EVSE 40A and EVSE 40B.

Each utility (which is also referred to as a “parent AG” below) belonging to upper aggregator E2 manages a plurality of utilities (each of which is also referred to as a “child AG” below) belonging to lower aggregator E3 and provides an energy management service by putting together amounts of electric power controlled by children AGs under the control thereof. The parent AG can make a profit, for example, by dealing with electric power utility company E1.

Server 10 manages information on a plurality of parent AGs (for example, parent AGs registered in server 10) under the control thereof. Identification information (ID) for identification of a parent AG is provided for each parent AG. Server 10 manages information for each parent AG as being distinguished based on an ID of the parent AG. The parent AG may procure performance (capacity) of supply of electricity not only from a battery electric vehicle (BEV) but also from a resource other than the BEV (for example, biomass). Upper aggregator E2 includes a plurality of servers (for example, servers 20A to 20C) provided for respective parent AGs. The server included in upper aggregator E2 is denoted as a “server 20” except for an example in which the servers are described as being distinguished from one another. Though FIG. 1 shows three servers 20 (servers 20A to 20C), any number of servers 20 may be included in upper aggregator E2 and ten or more servers may be included.

Each server 20 included in upper aggregator E2 manages information on children AGs (for example, children AGs registered in server 20) under the control thereof. Each utility (child AG) belonging to lower aggregator E3 controls an amount of electric power by requesting each demand side to suppress or increase power demand by issuing a demand response signal (DR signal). Identification information (ID) for identification of a child AG is provided for each child AG. Server 20 manages information for each child AG as being distinguished based on an ID of the child AG. Lower aggregator E3 includes a plurality of servers (for example, servers 30A to 30C) provided for respective children AGs. The server included in lower aggregator E3 is denoted as a “server 30” below except for an example in which the servers are described as being distinguished from one another. Servers 30A to 30C shown in FIG. 1 are managed by common server 20 (for example, server 20B). Any number of servers 30 may be managed by each server 20 included in upper aggregator E2, and ten or more servers may be managed.

A battery electric vehicle (BEV) is adopted as the demand side managed by a child AG (or server 30) in VGI system 1 shown in FIG. 1. The BEV can be supplied with electric power by electric vehicle supply equipment (EVSE). In this embodiment, VGI system 1 includes both of EVSE adapted to an alternating-current electric power supply type (an AC type) and EVSE adapted to a direct-current electric power supply type (a DC type).

EVSE 40A included in VGI system 1 shown in FIG. 1 is home EVSE (that is, EVSE installed in a house). The home EVSE can be managed by a home energy management system-gateway (HEMS-GW). For example, EVSE 40A is managed by a HEMS-GW 60. EVSE 40B included in VGI system 1 shown in FIG. 1 is public EVSE. The public EVSE is installed, for example, in public facilities, commercial facilities, accommodations, and parking lots (for example, service areas of highways) as an infrastructure for charging of a power storage mounted on an electrically powered vehicle. Typical examples of public EVSE include a normal charger adapted to the AC type and a quick charger adapted to the DC type.

VGI system 1 includes a plurality of pieces of EVSE, a plurality of BEVs, and a plurality of HEMS-GWs (only one of each of them being shown in FIG. 1). Any independent number of pieces of EVSE, BEVs, and HEMS-GWs may be included in VGI system 1, and the number may be set to ten or more or one hundred or more. Each piece of EVSE, each BEV, and each HEMS-GW included in VGI system 1 are denoted as “EVSE 40,” “BEV 50,” and “HEMS-GW 60,” respectively, except for an example in which each of them is described as being distinguished. Each BEV 50 included in VGI system 1 may be a vehicle owned by an individual (which is also referred to as a “POV” below) or a vehicle managed by a mobility as a service (MaaS) entity (which is also referred to as a “MaaS vehicle” below). In this embodiment, a user of each BEV 50 included in VGI system 1 enters into a contract with electric power utility company E1. Under this contract, the user obtains the right to receive a reward from electric power utility company E1 when the user adjusts power demand in response to a request by electric power utility company E1. Electric power utility company E1 according to this embodiment corresponds to an exemplary “contracted utility.”

Each server 30 included in lower aggregator E3 manages information on a plurality of BEVs 50 (for example, BEVs registered in server 30) under the control thereof. Identification information for identification of BEV 50 (which is also referred to as a “vehicle ID” below) is provided for each BEV 50. Server 30 manages information for each BEV 50 as being distinguished based on the vehicle ID. Each server 30 included in lower aggregator E3 can communicate with each HEMS-GW 60 (for example, a HEMS-GW registered in server 30) under the control thereof.

EVSE 40A is connected to the power grid of electric power utility company E1 with smart meter 13A being interposed. An amount of power usage in EVSE 40A is measured by smart meter 13A and transmitted to server 10. EVSE 40B is connected to the power grid of electric power utility company E1 with smart meter 13B being interposed. An amount of power usage in EVSE 40B is measured by smart meter 13B and transmitted to server 10. Each of smart meters 13A and 13B included in VGI system 1 is denoted as a “smart meter 13” below except for an example in which the smart meters are described as being distinguished from each other.

Smart meter 13 is provided for each piece of EVSE 40 included in VGI system 1. Each piece of EVSE 40 included in VGI system 1 is managed by electric power utility company E1 and connected to the power grid provided by electric power utility company E1. Each piece of EVSE 40 included in VGI system 1 is supplied with electric power from electric power utility company E1. In VGI system 1, identification information for identification of EVSE 40 (which is also referred to as a “facility ID” below) is provided for each piece of EVSE 40, and server 10 manages an amount of power usage in each piece of EVSE 40 as being distinguished based on the facility ID. Electric power utility company E1 monitors an amount of electric power used in each piece of EVSE 40 included in VGI system 1 (that is, an amount of supply of electric power to a demand side) through smart meter 13 and provides electric power to the demand side through each piece of EVSE 40 included in VGI system 1.

A plurality of pieces of EVSE 40 included in VGI system 1 include a charging facility not adapted to backfeeding and a charging facility adapted to backfeeding (that is, a charging and discharging facility). The charging and discharging facility supplies electric power received from BEV 50 to the power grid of electric power utility company E1 (that is, backfeeding). Smart meter 13 provided in the charging and discharging facility measures an amount of backfed electric power in addition to an amount of power usage.

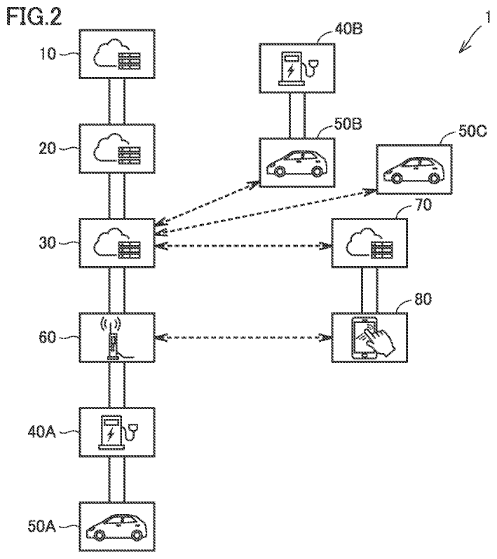

A function of each element included in VGI system 1 will be described below with reference to FIG. 2. FIG. 2 is a diagram of a communication system of VGI system 1. In FIG. 2, BEV 50A is electrically connected to EVSE 40A (home EVSE) through a charging cable. BEV 50B is electrically connected to EVSE 40B (public EVSE) through a charging cable. A BEV 50C is traveling.

Referring to FIG. 2, in VGI system 1, server 10 and server 20 can communicate with each other. Server 20 and server 30 can also communicate with each other. Though communication between servers 10 and 20 and between servers 20 and 30 may be independently of any type, for example, a virtual private network (VPN) may be adopted.

Server 30 can communicate with each of each BEV 50 (that is, BEVs 50A to 50C) and HEMS-GW 60. Server 30 and HEMS-GW 60 communicate with each other, for example, through the Internet. Server 30 and each BEV 50 wirelessly communicate with each other, for example, through a mobile communication network (telematics).

HEMS-GW 60 and EVSE 40A communicate with each other, for example, through a local area network (LAN). The LAN may be wired or wireless LAN.

EVSE 40A and BEV 50A communicate with each other through a charging cable. EVSE 40B and BEV 50B communicate with each other also through a charging cable. Communication between EVSE 40A and BEV 50A and between EVSE 40B and BEV 50B may be independently of any type, and controller area network (CAN) or power line communication (PLC) may be adopted.

VGI system 1 further includes a data center 70 and a portable terminal 80 registered in data center 70. Data center 70 includes, for example, a server (not shown) that manages information. In this embodiment, a smartphone equipped with a touch panel display is adopted as portable terminal 80. Without being limited thereto, any portable terminal can be adopted as portable terminal 80, and for example, a tablet terminal, a portable game console, and a wearable device such as a smart watch can also be adopted.

Data center 70 communicates with server 30, for example, through the Internet. Data center 70 manages information on a plurality of registered portable terminals 80. Information on portable terminal 80 includes not only information on the terminal itself (for example, a communication address of portable terminal 80) but also information on a user who carries portable terminal 80 (for example, information that indicates an electric utility with which the user has contracted and a vehicle ID of BEV 50 belonging to the user). Identification information for identification of portable terminal 80 (which is also referred to as a “terminal ID” below) is provided for each portable terminal 80 and data center 70 manages information for each portable terminal 80 as being distinguished based on the terminal ID. The terminal ID also functions as information for identification of a user (a user ID). Though FIG. 2 shows only a single portable terminal 80, each user carries portable terminal 80.

Prescribed application software (which is simply referred to as an “application” below) is installed in portable terminal 80, and portable terminal 80 exchanges information with each of HEMS-GW 60 and data center 70 through the application. Portable terminal 80 wirelessly communicates with each of HEMS-GW 60 and data center 70, for example, through the Internet.

Server 10 balances between supply and demand of electric power by using demand response (DR). When server 10 makes such adjustment, initially, it transmits a signal (which is also referred to as a “DR participation request” below) requesting each server 20 (for example, servers 20A to 20C shown in FIG. 1) included in upper aggregator E2 to participate in DR. The DR participation request includes a region of interest of DR, a type of DR (for example, DR suppression (negawatt DR) or DR increase (posiwatt DR)), and a DR period.

When server 20 receives a DR participation request from server 10, it calculates an adjustable DR amount (that is, an amount of electric power that can be adjusted in accordance with DR) and transmits the amount to server 10. Server 20 can calculate the adjustable DR amount, for example, based on a total of DR capacities of children AGs (that is, a capacity with which the children AGs can address DR) under the control thereof. Server 20 can obtain the DR capacity of each child AG under the control thereof, for example, by making an inquiry to server 30. Server 10 determines a DR amount (that is, an amount of power adjustment asked to a parent AG) for each parent AG based on the adjustable DR amount received from each server 20 included in upper aggregator E2 and transmits a signal (which is also referred to as a “first DR execution instruction” below) instructing server 20 of each parent AG to execute DR. The first DR execution instruction includes a region of interest of DR, a type of DR (for example, DR suppression or DR increase), an amount of DR for the parent AG, and a DR period.

Server 30 sequentially obtains from each BEV 50, information (for example, a position of a vehicle, a remaining capacity of a battery, a travel schedule, and a travel condition) representing a state of each BEV 50 under the control thereof and stores the information. As a result of accumulation of such data, a history of charging and discharging and a history of travel of each BEV 50 under the control are stored in server 30. Server 30 sequentially obtains from each HEMS-GW 60 connected to each piece of EVSE 40, information representing a state (for example, information indicating whether or not the vehicle is being charged, a schedule for charging, and a condition for charging) of each piece of EVSE 40 under the control thereof and stores the information. As a result of accumulation of such data, a history of charging and a history of backfeeding of each piece of EVSE 40 under the control are stored in server 30.

A user can transmit information representing a state and a schedule of the user to data center 70 by operating portable terminal 80. Exemplary information representing a state of the user includes information indicating whether or not the user is in a condition of being ready for addressing DR. Exemplary information representing the schedule of the user includes time of departure of a POV from home or a drive plan of a MaaS vehicle. Data center 70 stores the information received from portable terminal 80 as being distinguished for each terminal ID. Server 30 can obtain information on the user from data center 70.

When server 30 receives the previously-described inquiry from server 20, server 30 calculates the DR capacity of a child AG corresponding thereto based on information on each of BEV 50, EVSE 40, and the user described above, and transmits the DR capacity to server 20. When server 20 receives the previously-described first DR execution instruction from server 10, server 20 determines a DR amount for each child AG (that is, an amount of electric power of which adjustment is asked to the child AG) based on the DR capacity received from each server 30 included in lower aggregator E3 and transmits a signal (which is also referred to as a “second DR execution instruction” below) that instructs server 30 of each child AG to execute DR. The second DR execution instruction includes a region of interest of DR, a type of DR (for example, DR suppression or DR increase), an amount of DR for the child AG, and a DR period.

When server 30 receives the second DR execution instruction, it allocates the DR amount to each BEV 50 that can address DR among BEVs 50 under the control thereof, generates a DR signal for each BEV 50, and transmits the DR signal to each BEV 50. The DR signal includes a type of DR (for example, DR suppression or DR increase), an amount of DR for BEV 50, and a DR period. A DR amount in DR increase requested to BEV 50 during the DR period may be, for example, charging power during the DR period or an amount of charging during the DR period (that is, a time integrated value of charging power). A DR amount in DR suppression requested to BEV 50 during the DR period may be, for example, an amount of discharging during the DR period (that is, a time integrated value of discharging power) or a guard value for restriction of charging power (an upper limit value of charging power) during the DR period.

When the user of each BEV 50 included in VGI system 1 receives the DR signal, the user can contribute to adjustment of an amount of power demand by performing charging or discharging in accordance with DR by using a charging facility (that is, any of a plurality of pieces of EVSE 40 included in VGI system 1) managed by electric power utility company E1 which is the contracted utility. Then, the user who has contributed to adjustment of the amount of power demand has the right to receive a reward (compensation for contribution) from electric power utility company E1 based on the contract with electric power utility company E1 described previously.

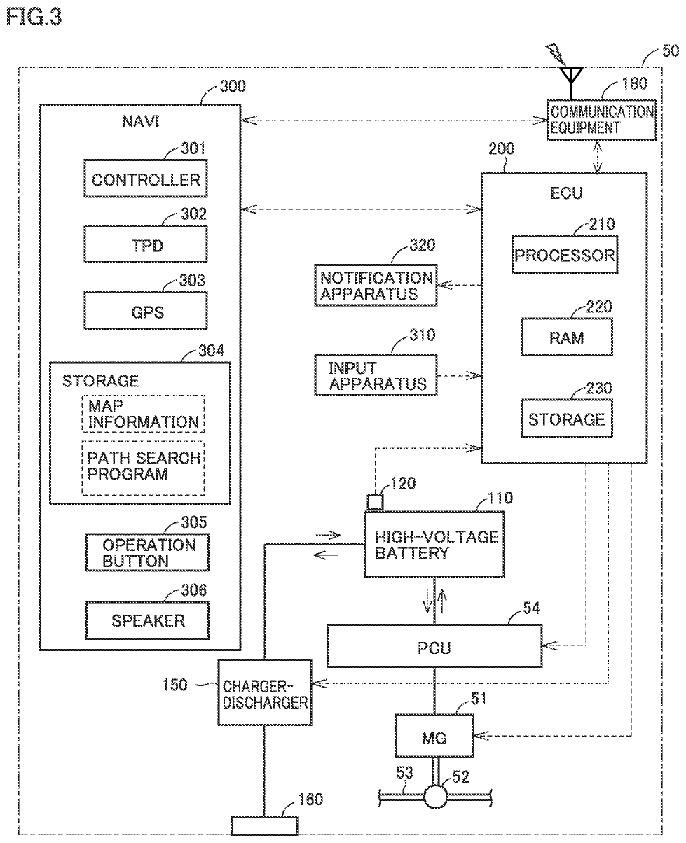

FIG. 3 is a diagram showing a configuration of BEV 50. Referring to FIG. 3, BEV 50 includes a motor generator (which is referred to as an “MG” below) 51, a motive power transmission gear 52, a driveshaft 53, a power control unit (which is referred to as a “PCU” below) 54, a high-voltage battery 110, a monitoring unit 120, a charger-discharger 150, an inlet 160, communication equipment 180, an electronic control unit (which is referred to as an “ECU” below) 200, a car navigation system (which is also referred to as a “NAVI system” below) 300, an input apparatus 310, and a notification apparatus 320. ECU 200 controls charging and discharging of high-voltage battery 100.

High-voltage battery 110 stores electric power for traveling. High-voltage battery 110 includes, for example, a secondary battery such as a lithium ion battery or a nickel metal hydride battery. The secondary battery may be a cell or a battery assembly. Instead of the secondary battery, another power storage such as an electric double layer capacitor may be adopted.

Inlet 160 receives electric power supplied from the outside of BEV 50. A connector 43 of a charging cable 42 can be connected to inlet 160.

Charger-discharger 150 is located between inlet 160 and high-voltage battery 110. Charger-discharger 150 includes a relay that switches between connection and disconnection of an electric power path from inlet 160 to high-voltage battery 110 and a power conversion circuit (for example, a bidirectional converter) (neither of which is shown). Each of the relay and the power conversion circuit included in charger-discharger 150 is controlled by ECU 200.

As EVSE 40 outside BEV 50 and inlet 160 are connected to each other through charging cable 42, electric power can be supplied and received between EVSE 40 and BEV 50. For example, electric power can be supplied from the outside of BEV 50 to charge high-voltage battery 110 of BEV 50 (which is also referred to as “external charging” below). Electric power for external charging is supplied, for example, from EVSE 40 through charging cable 42 to inlet 160. Charger-discharger 150 converts electric power received at inlet 160 into electric power suitable for charging of high-voltage battery 110 and outputs resultant electric power to high-voltage battery 110. As EVSE 40 and inlet 160 are connected to each other through charging cable 42, electric power can be fed (and high-voltage battery 110 can be discharged) from BEV 50 through charging cable 42 to EVSE 40. Electric power for power feed to the outside of BEV 50 (which is also referred to as “external power feed” below) is supplied from high-voltage battery 110 to charger-discharger 150. Charger-discharger 150 converts electric power supplied from high-voltage battery 110 into electric power suitable for external power feed and outputs resultant electric power to inlet 160. When any of external charging and external power feed is performed, the relay of charger-discharger 150 is closed (connected), and when neither of external charging and external power feed is performed, the relay of charger-discharger 150 is opened (disconnected).

Charger-discharger 150 and inlet 160 may be a charger-discharger and an inlet adapted to the AC type or may be a charger-discharger and an inlet adapted to the DC type. BEV 50 may include a plurality of types of chargers-dischargers and inlets so as to adapt to a plurality of types (for example, both of the AC type and the DC type). The configuration of charger-discharger 150 is not limited as above and can be modified as appropriate. Charger-discharger 150 may include, for example, at least one of a rectification circuit, a power factor correction circuit, an insulating circuit (for example, an insulating transformer), an inverter, and a filter circuit.

MG 51 is implemented, for example, by a three-phase AC motor generator. MG 51 is driven by PCU 54 and generates driving force for traveling of BEV 50. PCU 54 includes, for example, a controller including a processor, an inverter, and a converter (none of which is shown). The controller of PCU 54 receives an instruction (a control signal) from ECU 200 and controls the inverter and the converter of PCU 54 in accordance with the instruction. PCU 54 further includes a not-shown system main relay (which is referred to as an “SMR” below). The SMR switches between connection and disconnection of an electric power path from high-voltage battery 110 to PCU 54. A state of the SMR (connection and disconnection) is controlled by ECU 200. The SMR is closed (connected) when the vehicle travels.

MG 51 is mechanically connected to driveshaft 53 with motive power transmission gear 52 serving as a reduction gear being interposed. Drive wheels (not shown) of BEV 50 are attached to respective opposing ends of driveshaft 53 and rotate integrally with driveshaft 53. MG 51 is driven by electric power supplied from high-voltage battery 110 through the inverter and the converter of PCU 54 and enters a power running state. MG 51 in the power running state rotates driveshaft 53 (and the drive wheels of BEV 50). MG 51 performs regeneration and supplies regenerated electric power to high-voltage battery 110. BEV 50 may be of any drive type, and for example, the BEV may be a front-wheel-drive vehicle or a four-wheel-drive vehicle. Though FIG. 3 shows a configuration in which only a single MG is provided, the number of MGs is not limited as such and a plurality of (for example, two) MGs may be provided.

Monitoring unit 120 includes various sensors that detect a state (for example, a temperature, a current, and a voltage) of high-voltage battery 110 and outputs a result of detection to ECU 200. ECU 200 can obtain a state (for example, a temperature, a current, a voltage, a state of charge (SOC), and an internal resistance) of high-voltage battery 110 based on an output (that is, detection values from various sensors) from monitoring unit 120. The SOC represents a remaining amount of stored power, and it is expressed, for example, as a ratio of a current amount of stored power to an amount of stored power in a fully charged state that ranges from 0 to 100%.

Communication equipment 180 includes a communication interface (I/F) for communication with each of server 30, EVSE 40, and portable terminal 80. Communication equipment 180 is registered in server 30. Communication equipment 180 may further include a communication OF for communication with each of HEMS-GW 60 and data center 70.

ECU 200 includes a processor 210, a random access memory (RAM) 220, and a storage 230. For example, a central processing unit (CPU) can be adopted as processor 210. RAM 220 functions as a work memory that temporarily stores data to be processed by processor 210. Storage 230 can store information that is put thereinto. Storage 230 includes, for example, a read only memory (ROM) and a rewritable non-volatile memory. Storage 230 stores not only a program but also information (for example, a map, a mathematical expression, and various parameters) to be used by a program. ECU 200 communicates with equipment (for example, server 30, EVSE 40, and portable terminal 80) outside BEV 50 through communication equipment 180. Any number of processors may be provided in ECU 200 and a processor may be prepared for each prescribed type of control.

NAVI system 300 includes a controller 301, a touch panel display (which is also referred to as a “TPD” below) 302, a global positioning system (GPS) module 303, a storage 304, an operation button 305, and a speaker 306. Controller 301 includes a processor and a RAM (neither of which is shown). For example, at least one of a hard disk drive and a solid state drive (SSD) can be adopted as storage 304. Storage 304 stores map information and a path search program. In this embodiment, a smart speaker (that is, a speaker with an interactive and voice-activated artificial intelligence (AI) assistant function) is adopted as speaker 306. Without being limited as such, a general speaker that does not accept audio input may be adopted instead of the smart speaker.

TPD 302 accepts a touch input from a user or shows a map and other types of information. Speaker 306 accepts an audio input from a user or outputs sound (including voice). Operation button 305 also accepts an input from a user. Each of TPD 302, speaker 306, and operation button 305 functions as an input apparatus and outputs a signal corresponding to an input from the user to controller 301. Each of TPD 302 and speaker 306 functions as a notification apparatus and gives a notification to the user (for example, a driver and/or a passenger of BEV 50).

GPS module 303 receives a signal (which is referred to as a “GPS signal” below) from a GPS satellite (not shown). Controller 301 identifies a position of BEV 50 based on the GPS signal. By controlling TPD 302, controller 301 shows in real time a position of BEV 50 on a map shown on TPD 302. Controller 301 searches for a path for finding an optimal route (for example, the shortest route) from the current position of BEV 50 to a destination by executing a path search program, and shows the optimal route found by path search on the map shown on TPD 302. The user can set a destination in controller 301 through the input apparatus (that is, TPD 302, speaker 306, and operation button 305) described above.

Input apparatus 310 is mounted on BEV 50 separately from an input apparatus of NAVI system 300. Input apparatus 310 accepts an input from a user and outputs a signal corresponding to the input from the user to ECU 200. Communication between ECU 200 and input apparatus 310 may be wired or wireless. Examples of input apparatus 310 include various switches, various pointing devices, a keyboard, a smart speaker, and a touch panel.

Notification apparatus 320 is mounted on BEV 50 separately from a notification apparatus of NAVI system 300. Notification apparatus 320 performs prescribed processing for giving a notification to a user (for example, a driver and/or a passenger of BEV 50) when a request is given from ECU 200. Any of a display apparatus (for example, a touch panel display), a speaker (for example, a smart speaker), and a lamp (for example, a malfunction indicator lamp (MIL)) may be adopted as notification apparatus 320.

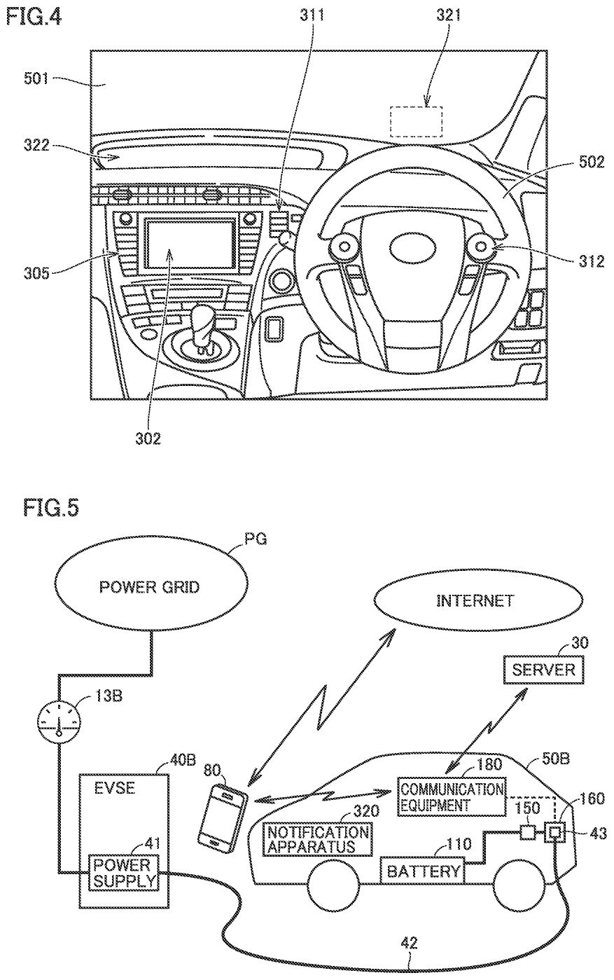

FIG. 4 is a diagram showing the input apparatus and the notification apparatus mounted in the vicinity of a driver's seat of BEV 50. Referring to FIG. 4, BEV 50 includes operation buttons 311 and 312, a head-up display (which is referred to as a “HUD” below) 321, and a meter panel 322. Operation buttons 311 and 312 are included in input apparatus 310 (FIG. 3) described previously. Operation button 311 is provided in an instrumental panel of BEV 50. Operation button 312 is provided in a steering wheel 502 of BEV 50. Each of HUD 321 and meter panel 322 is included in notification apparatus 320 (FIG. 3) described previously. HUD 321 is a display provided in a windshield 501 of BEV 50. Meter panel 322 is located in the vicinity of windshield 501 and shows information on BEV 50 (for example, a remaining capacity of the battery (SOC), a traveling speed, a travel distance, average specific power consumption, and an outdoor temperature). TPD 302 and operation button 305 of NAVI system 300 (FIG. 3) are provided in the instrumental panel of BEV 50. A main body of NAVI system 300 is arranged in the instrumental panel.

FIG. 5 is a diagram for illustrating BEV 50B connected to public EVSE 40B. Referring to FIG. 5, BEV 50B is electrically connected to EVSE 40B through charging cable 42 while it is parked in a parking lot where EVSE 40B is installed. Charging cable 42 includes connector 43 at its tip end. As connector 43 of charging cable 42 connected to EVSE 40B is connected to inlet 160 of BEV 50B, communication between BEV 50B and EVSE 40B can be established and electric power can be supplied from a power supply 41 (that is, a power supply provided outside BEV 50B) included in EVSE 40B to BEV 50B (and high-voltage battery 110). Power supply 41 is connected to power grid PG provided by electric power utility company E1 (FIG. 1) with smart meter 13B being interposed. Power supply 41 supplies electric power supplied from power grid PG to BEV 50B through charging cable 42. An amount of power usage in EVSE 40B is measured by smart meter 13B.

Communication equipment 180 mounted on BEV 50B communicates with EVSE 40B through charging cable 42. Communication equipment 180 wirelessly communicates with server 30, for example, through a mobile communication network. In this embodiment, communication equipment 180 and portable terminal 80 wirelessly communicate with each other. Communication equipment 180 and portable terminal 80 may communicate with each other through short-range communication (for example, direct communication in a vehicle or within an area around the vehicle). Though server 30 and EVSE 40B do not communicate with each other in this embodiment, server 30 and EVSE 40B may be able to communicate with each other. At least one of communication equipment 180 and portable terminal 80 may receive an amount of power usage in EVSE 40B from smart meter 13B. At least one of notification apparatus 320 and portable terminal 80 may show at least one of a value measured by smart meter 13B, a DR amount allocated to BEV 50B, and a rate of achievement of the DR amount during charging or discharging of high-voltage battery 110.

EVSE 40 includes specific EVSE 40 available only to specific BEV 50 among BEVs 50, specific BEV 50 being permanently permitted to use EVSE 40 (for example, not only BEV 50 permanently permitted to use EVSE but also BEV 50 originally permitted to use EVSE and BEV 50 of a user of a facility including a parking lot where EVSE 40 is provided). In utilization of BEV 50 as the electric power resource, utilization of not only public EVSE 40 available to all BEVs 50 but also specific EVSE 40 such as EVSE 40 privately used by each entity may be assumed.

The management server (for example, any of servers 10, 20, and 30) performs processing for temporarily permitting use of specific EVSE 40 by non-specific BEV 50 different from specific BEV 50 (for example, processing for direct permission or processing for indirect permission by obtaining permission from the manager of specific EVSE 40) on condition that non-specific BEV 50 uses specific EVSE 40 to exchange electric power with electric power utility company E1 and performs processing for granting an incentive to the user of non-specific BEV 50 or the manager of specific EVSE 40 on condition that non-specific BEV 50 has exchanged electric power with electric power utility company E1.

Thus, even non-specific BEV 50 different from specific BEV 50 permanently permitted to use specific EVSE 40 can be used for exchange at specific EVSE 40, of electric power with power grid PG of electric power utility company E1. Consequently, opportunities for utilization of BEV 50 for exchange of electric power can be increased.

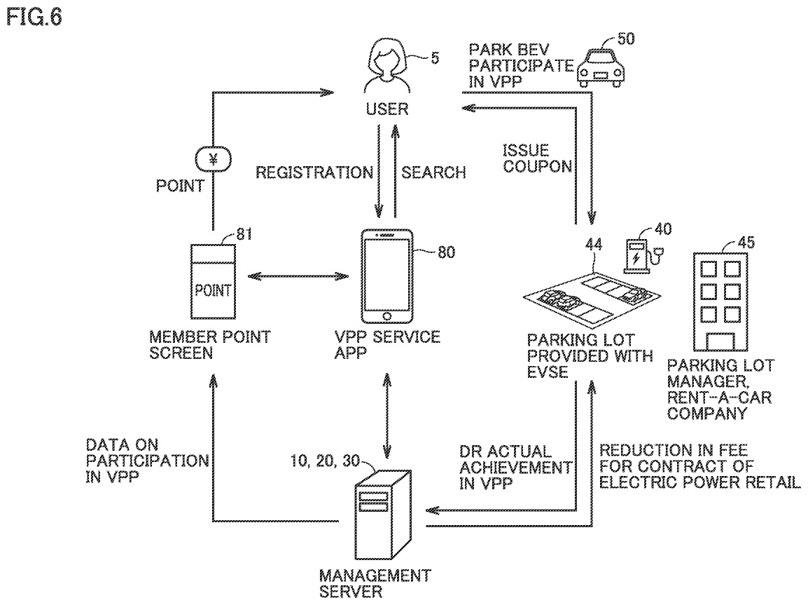

FIG. 6 is a diagram for illustrating overview of search for a parking lot 44 provided with EVSE 40 in the first embodiment. Initially, a user 5 installs a specific application created by an entity that provides the VPP service in portable terminal 80. As user 5 starts up this specific application, the user can search for parking lot 44 including specific EVSE 40 available only to specific BEV 50 different from BEV 50 of user 5.

Such a parking lot 44 is, for example, a parking lot managed by a manager 45 such as a parking lot manager such as a company, an individual, or a real estate company or a rent-a-car company. In parking lot 44 managed by a company, for example, an employee and an associate thereof are permitted to park their cars. On a day when the company is closed or the like, more free parking spaces are available and non-specific BEV 50 can also be parked. In parking lot 44 managed by an individual or a real estate company, a contracted user can park his/her car. When the number of contracted cars is smaller than the number of parking spaces, non-specific BEV 50 can be parked in a free parking space. In parking lot 44 of a rent-a-car company, rental cars managed by the company can be parked, and non-specific BEV 50 can be parked in a free parking space depending on a status of operation of rental cars.

EVSE 40 in a parking lot that can be searched for is prepared to participate in the VPP managed by the management server which is any of servers 10, 20, and 30. User 5 goes to the parking lot found as a result of search, connects his/her BEV 50 to EVSE 40, and participates in the designated VPP. In return, user 5 is granted an incentive by receiving a coupon or the like.

The management server obtains DR actual achievement by BEV 50 in the VPP from EVSE 40, and transmits data on participation in the VPP such as the DR actual achievement in the VPP to the entity that provides the VPP service. The entity that provides the VPP service grants user 5 the incentive by granting user 5 points in accordance with a status of participation in the VPP indicated by the data on participation in the VPP. User 5 can check the granted points on a member point screen 81 of the specific application.

The management server grants the incentive such as reduction in fee for contract of electric power retail to manager 45 such as the parking lot manager or the rent-a-car company, depending on a status of offering of EVSE 40 to the VPP. The management server may grant the incentive to the manager in accordance with the scale or performance of specific EVSE 40. The entity that provides the VPP service may be the same as electric power utility company E1, upper aggregator E2, or lower aggregator E3.

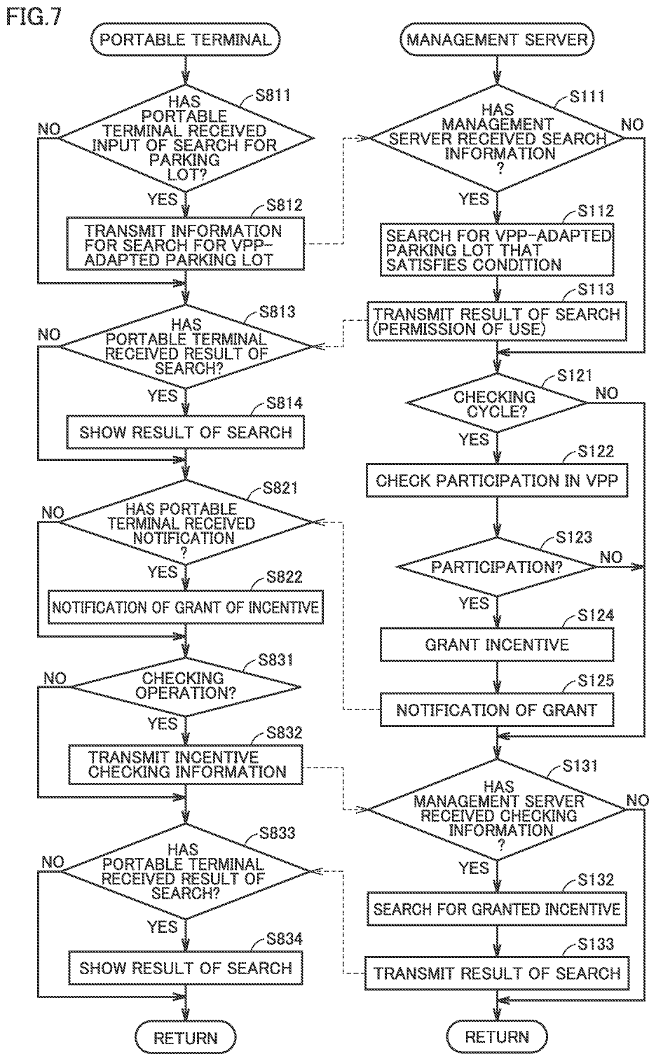

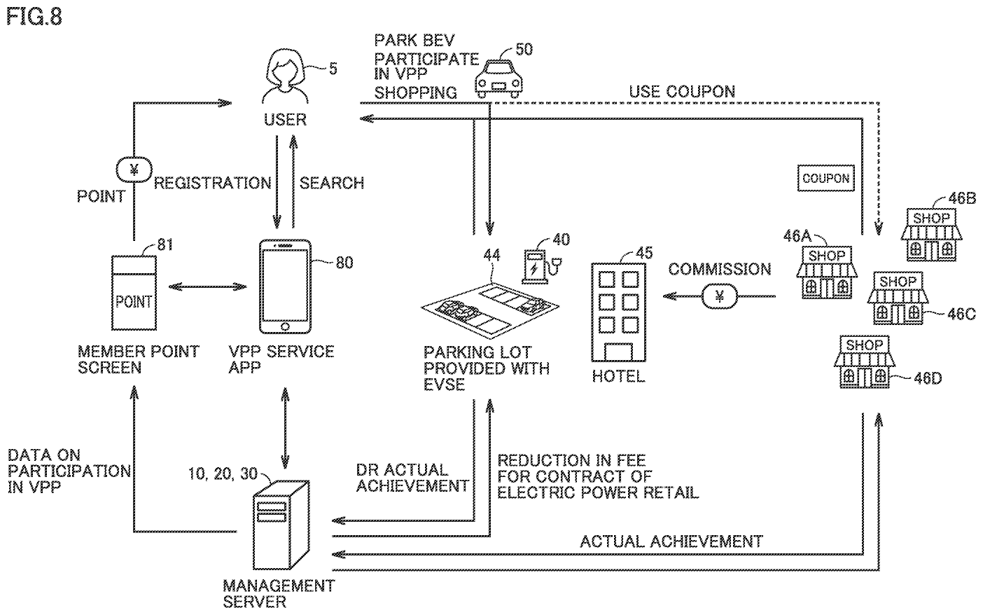

FIG. 7 is a flowchart showing a flow of processing for search for parking lot 44 including EVSE 40 that can participate in the VPP in VGI system 1 in this embodiment. Referring to FIG. 7, the CPU of portable terminal 80 determines whether or not it has received input of information on time and day of use and an area of use for search for parking lot 44 from the touch panel display (step S811).

When the CPU determines that it has received input of information on search for a parking lot (YES in step S811), the CPU transmits to the management server (any of servers 10, 20, and 30), the information on time and day of use and the area of use for search for parking lot 44 where a BEV can participate in the VPP (step S812).

The CPU of the management server determines whether or not it has received search information from portable terminal 80 (step S111). When the CPU of the management server determines that it has received the search information (YES in step S111), it searches for parking lot 44 where the BEV can participate in the VPP that satisfies a search condition (step S112), and transmits a result of search (including information indicating permission of use of the parking lot) to portable terminal 80 (step S113). The CPU of the management server may search for specific EVSE 40 available on a day when specific BEV 50 does not use the parking lot (for example, a regular day-off of the entity where there is parking lot 44 available to a guest).

When the CPU of portable terminal 80 determines that it has not received input of the information on search for a parking lot (NO in step S811) or after step S812, it determines whether or not it has received a result of search from the management server (step S813). When the CPU of portable terminal 80 determines that it has received the result of search (YES in step S813), it has information on parking lot 44 including EVSE 40 that can participate in the VPP indicated in the result of search shown on the touch panel display (step S814).

When the CPU of the management server determines that it has not received the search information (NO in step S111) or after step S113, it determines whether or not a cycle (for example, a five-minute cycle or a one-minute cycle) to check participation by BEV 50 in the VPP at EVSE 40 in parking lot 44 has come (step S121). When the CPU of the management server determines that the checking cycle has come (YES in step S121), it checks a status of participation by BEV 50 in the VPP at EVSE 40 in parking lot 44 (step S122).

The CPU of the management server then determines whether or not BEV 50 has participated in the VPP (step S123). When the CPU of the management server determines that BEV 50 has participated in the VPP (YES in step S123), it performs processing for asking the entity that provides the VPP service to grant an incentive to user 5 of BEV 50 as processing for granting the incentive to user 5 (step S124). The CPU of the management server may perform processing for directly granting the incentive to user 5 of BEV 50 as processing for granting the incentive to user 5. As described above, the management server may grant the incentive such as reduction in fee for contract of electric power retail to manager 45 such as the parking lot manager or the rent-a-car company, depending on the status of offering of EVSE 40 to the VPP. The management server may grant the manager the incentive in accordance with the scale or performance of specific EVSE 40.

The CPU of the management server then performs processing for asking the entity that provides the VPP service to notify portable terminal 80 of user 5 of grant of the incentive as processing for notifying portable terminal 80 of user 5 of grant of the incentive (step S125). The CPU of the management server may perform processing for directly notifying portable terminal 80 of user 5 of grant of the incentive as processing for notifying portable terminal 80 of user 5 of grant of the incentive.

When the CPU of portable terminal 80 determines that it has not received the result of search (NO in step S813) or after step S814, it determines whether or not it has received the notification of grant of the incentive (step S821). When the CPU of portable terminal 80 determines that it has received the notification (YES in step S821), it controls the touch panel display and the speaker to provide the notification of grant of the incentive (step S822).

When the CPU of portable terminal 80 determines that it has not received the notification (NO in step S821) or after step S822, it determines whether or not an operation to check the granted incentive has been performed onto the touch panel display (step S831). When the CPU of portable terminal 80 determines that the checking operation has been performed (YES in step S831), it transmits information for checking the granted incentive to the management server (step S832).

When the CPU of the management server determines that the checking cycle has not come (NO in step S121), when it determines that BEV 50 has not participated in the VPP (NO in step S123), or after step S125, it determines whether or not it has received information for checking the granted incentive from portable terminal 80 (step S131). When the CPU of the management server determines that it has received the checking information (YES in step S131), it searches for the incentive granted to user 5 of portable terminal 80 which is the sender of the checking information (step S132) and transmits a result of search to portable terminal 80 (step S133).

When the CPU of portable terminal 80 determines that the checking operation has not been performed (NO in step S831), it determines whether or not it has received a result of search from the management server (step S833). When the CPU of portable terminal 80 determines that it has received the result of search (YES in step S833), it has the granted incentive indicated in the result of search shown on the touch panel display (step S834).

### Second Embodiment

In the first embodiment, parking lot 44 is assumed as a parking lot managed by manager 45. In return of participation by BEV 50 in the VPP, user 5 of BEV 50 is granted a coupon by the manager.

FIG. 8 is a diagram for illustrating overview of search for parking lot 44 including EVSE 40 in a second embodiment. In the second embodiment, parking lot 44 is a parking lot managed by manager 45 such as a hotel. As manager 45 permits use of parking lot 44 to a guest who uses nearby shops 46A to 46D for shopping or the like, the manager obtains a commission from shops 46A to 46D. Shops 46A to 46D grant a coupon to user 5 of BEV 50 in return of participation by BEV 50 in the VPP. User 5 can use the coupon at shops 46A to 46D. Shops 46A to 46D obtain from the management server which is any of servers 10, 20, and 30, such an incentive as reduction in fee for contract of electric power retail based on actual achievement of participation in the VPP by user 5 who uses shops 46A to 46D. Manager 45 can thus achieve improvement in utilization rate of the parking lot. Shops 46A to 46D can save their contract fees for the parking lot and can be prevented from losing customers to a suburban shopping complex.

[Modification]

(1) In the embodiments described previously, electric power utility company E1 is assumed as the electric power trading partner. Without being limited as such, another entity which is not a power generation utility such as electric power utility company E1 may be applicable as the electric power trading partner. The electric power trading partner may be, for example, a general power transmission and distribution utility, a retail electric utility, or a demand side of electric power such as a general entity.

(2) In the embodiments described previously, power grid PG is defined as the power supply and demand system of the electric power trading partner. Without being limited as such, another system may be defined as the power supply and demand system of the electric power trading partner. For example, a system of power lines in a business establishment may be applicable.

(3) In the embodiments described previously, BEV 50 is defined as the electrically powered vehicle. Without being limited as such, the electrically powered vehicle should only be a vehicle including a power storage and being capable of external charging and discharging. For example, a PHEV or a plug-in fuel cell electric vehicle (FCEV) may be applicable.

(4) The embodiments described previously can be understood as disclosure of such a power management system as VGI system 1, disclosure of the power management method in the power management system, disclosure of servers 10, 20, 30, EVSE 40, or BEV 50, or disclosure of the power management method performed in servers 10, 20, 30, EVSE 40, or BEV 50 or a power management program executed by servers 10, 20, 30, EVSE 40, or BEV 50.

### SUMMARY

(1) As shown in FIGS. 1 and 2, VGI system 1 is a system in which electric power is exchanged between power grid PG of electric power utility company E1 and BEV 50. As shown in FIGS. 1 and 2, VGI system 1 includes a plurality of BEVs 50, EVSE 40 including charging cable 42 through which electric power exchanged with BEV 50 passes and connector 43 for connection of charging cable 42 to BEV 50, and the management server (for example, any of servers 10, 20, and 30) that manages exchange of electric power. As shown in FIGS. 6 and 8, EVSE 40 includes specific EVSE 40 available to a specific vehicle of BEVs 50, the specific vehicle being permanently permitted to use EVSE 40 (for example, not only BEV 50 permanently permitted to use EVSE but also BEV 50 originally permitted to use EVSE and BEV 50 of a user of a facility including a parking lot where EVSE 40 is provided).

As shown in FIG. 7, the management server performs processing for temporarily permitting use of specific EVSE 40 by a non-specific vehicle different from the specific vehicle (which may be, for example, processing for direct permission or processing for indirect permission by obtaining permission from the manager of the specific charging and discharging facility) (for example, step S113) on condition that the non-specific vehicle uses specific EVSE 40 to exchange electric power with electric power utility company E1 and performs processing for granting an incentive to user 5 of the non-specific vehicle or a manager of specific EVSE 40 (for example, step S124) on condition that the non-specific vehicle has exchanged electric power with electric power utility company E1.

Thus, even the non-specific vehicle different from the specific vehicle permanently permitted to use specific EVSE 40 can be used for exchange at specific EVSE 40, of electric power with power grid PG of electric power utility company E1. Consequently, opportunities for utilization of the vehicle for exchange of electric power can be increased.

(2) As shown in FIG. 6, the management server may grant the manager the incentive in accordance with a scale or performance of specific EVSE 40.

The manager that offers specific EVSE 40 for utilization of the vehicle for exchange of electric power can thus be motivated to offer EVSE 40 larger in scale and higher in performance.

(3) As shown in FIG. 7, the management server searches for specific EVSE 40 in accordance with desire of user 5 of the non-specific vehicle in response to a request for search for specific EVSE 40 from user 5 and transmits a result of search to user 5 (for example, steps S811 to S814 and steps S111 to S113).

User 5 of the non-specific vehicle can thus be notified of specific EVSE 40 in accordance with desire of user 5. Consequently, convenience of user 5 can be improved.

(4) As shown in FIG. 7, the management server may search for specific EVSE 40 available on a day when the specific vehicle does not use specific EVSE 40 (for example, a regular day-off of an entity where there is a parking lot available to a guest) (for example, step S112).

Specific EVSE 40 can thus be made available to the non-specific vehicle on the day when the specific vehicle does not use specific EVSE 40.

Though embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power management system in which electric power is exchanged between a power supply and demand system of an electric power trading partner and a vehicle, the power management system comprising:
a plurality of vehicles;
a plurality of charging and discharging apparatuses each including a cable through which electric power exchanged with the vehicle passes and a connector for connection of the cable to the vehicle; and
a server that manages exchange of electric power, wherein
each charging and discharging apparatus of the charging and discharging apparatuses includes a specific charging and discharging facility available to a specific vehicle of the vehicles, the specific vehicle being permanently permitted to use the charging and discharging apparatus, and
the server
performs processing for temporarily permitting use the specific charging and discharging facility by a non-specific vehicle different from the specific vehicle on condition that the non-specific vehicle uses the specific charging and discharging facility to exchange electric power with the trading partner, and
performs processing for granting an incentive to a user of the non-specific vehicle or a manager of the specific charging and discharging facility on condition that the non-specific vehicle has exchanged electric power with the trading partner.

2. The power management system according to claim 1, wherein
the server grants the manager the incentive in accordance with a scale or performance of the specific charging and discharging facility.

3. The power management system according to claim 1, wherein
the server searches for the specific charging and discharging facility in accordance with desire of the user of the non-specific vehicle in response to a request for search for the specific charging and discharging facility and transmits a result of search to the user.

4. The power management system according to claim 3, wherein
the server searches for the specific charging and discharging facility available on a day when the specific vehicle does not use the specific charging and discharging facility.

5. A power management method in a power management system in which electric power is exchanged between a power supply and demand system of an electric power trading partner and a vehicle,
the power management system including
a plurality of vehicles,
a plurality of charging and discharging apparatuses each including a cable through which electric power exchanged with the vehicle passes and a connector for connection of the cable to the vehicle, and
a server that manages exchange of electric power,
each charging and discharging apparatus of the charging and discharging apparatuses including a specific charging and discharging facility available to a specific vehicle of the vehicles, the specific vehicle being permanently permitted to use the charging and discharging apparatus,
the power management method comprising:
performing, by the server, processing for temporarily permitting use the specific charging and discharging facility by a non-specific vehicle different from the specific vehicle on condition that the non-specific vehicle uses the specific charging and discharging facility to exchange electric power with the trading partner; and
performing, by the server, processing for granting an incentive to a user of the non-specific vehicle or a manager of the specific charging and discharging facility on condition that the non-specific vehicle has exchanged electric power with the trading partner.
